(19) United States
(12) Patent Application Publication
(10) Pub. No.: US 2017/0208606 A1
(43) Pub. Date: Jul. 20, 2017

(54) GROUP OPERATION METHOD AND DEVICE FOR LOGICAL CHANNELS IN LTE SYSTEM

(71) Applicant: Sanechips Technology Co.,Ltd., Shenzhen, Guangdong (CN)

(72) Inventor: Wei Chen, Shenzhen (CN)

(73) Assignee: Sanechips Technology Co., Ltd., Shenzhen, Guangdong (CN)

(21) Appl. No.: 15/326,565

(22) PCT Filed: Nov. 17, 2014
(86) PCT No.: PCT/CN2014/091327

§ 371 Date: Jan. 16, 2017

(30) Foreign Application Priority Data
Jul. 16, 2014 (CN) 201410339995.4

(51) Int. Cl. H04W 72/10; H04L 5/00; H04W 72/04

(52) U.S. Cl. CPC H04W 72/10; H04W 72/0453; H04W 72/0446; H04L 5/0082

(57) ABSTRACT

The disclosure discloses a group operation method for logical channels in a Long Term Evolution (LTE) system. The method includes that: data spaces are sequentially allocated to logical channels in a first array to complete group operation of the logical channels in the first array; and data spaces are sequentially allocated to logical channels in a second array to complete group operation of the logical channels in the second array, and sizes of the data spaces are sums of sizes of all data on the logical channels corresponding to the data spaces. The disclosure also discloses a group operation device for the logical channels in the LTE system.

### TECHNICAL FIELD

The disclosure relates to the technical field of Long Term Evolution (LTE) service data transmission, and particularly to a group operation method and device for logical channels in an LTE system.

### BACKGROUND

In an LTE service data transmission scenario, service data transmission includes sending of uplink data and reception of downlink data. In a protocol, a data transmission function is realized by three layers of Media Access Control (MAC), Radio Link Control (RLC) and Packet Data Convergence Protocol (PDCP). During the uplink data sending in the MAC layer, MAC Service Data Units (SDUs) on multiple logical channels are multiplexed into a transmission block (which is called as group operation for short) to form MAC Protocol Data Units (PDUs), and then are transmitted to a physical layer and sent on an air interface; and during downlink data reception, MAC SDUs on multiple logical channels in a transmission block are demultiplexed and transmitted to the RLC layer for subsequent processing. The MAC SDUs are datasets of user service, and include various types of data.

During uplink multiplexing of the MAC SDUs in the MAC layer, it is necessary to perform logical channel priority processing, and a method for the logical channel priority processing is as follows.

Step a: a priority value is defined for each logical channel, and meanwhile, and a B value is maintained for each logical channel. The B value is the token bucket value of the logical channel. Bⱼ is the B value of the jth logical channel, and j is a natural number.

Step b: data spaces are allocated to the logical channels of which Bᵢ is larger than 0 according to priorities of the logical channels, and if Prioritised Bit Rate (PBR) is set to be infinitely large, sufficient resources are allocated to the corresponding logical channel to group all data on the logical channel.

Step c: sizes of MAC SDUs formed in Step b are subtracted from the Bⱼ values of each logical channel.

Step d: if there is still left a data space, data spaces are allocated to the logical channels according to a sequence from high to low priorities, and sufficient resources are allocated to each logical channel to group all the data on the logical channels.

When the abovementioned method is adopted for logical channel group operation, group operation is performed on the logical channels of which the Bⱼ values are larger than 0 in Step a, and group operation is performed on the logical channels according to the sequence from the high to low priorities in Step d. When there is a logical channel simultaneously meeting the conditions that Bⱼ is larger than 0 and the priority is high, the group operation in Step a and that in Step d are both performed. Consequently, group operation is performed on the same logical channel twice in the same period, and group operation performed twice may cause increase of a fragment number as well as a more complex process; and meanwhile, group operation may not be performed on a logical channel of which Bⱼ is smaller than or equal to 0 and the priority is low in the same period, and this causes low data processing efficiency.

In a conventional art, there is a method for combining resources allocated to the same logical channel in Step a and Step d to perform group operation only once on the same logical channel, but the method requires addition of resource combination processing; and moreover, a progressive decrease operation process for Bⱼ is also complex.

### SUMMARY

In view of this, the embodiment of the disclosure is intended to provide a group operation method and device for logical channels in an LTE system, which may solve the problem that group operation is performed on the same logical channel twice in the same period by an existing logical channel group operation method.

To this end, the technical solutions of the disclosure are implemented as follows.

The embodiment of the disclosure provides a group operation method for logical channels in an LTE system, which may include that:

data spaces are sequentially allocated to logical channels in a first array to complete group operation of the logical channels in the first array; and

data spaces are sequentially allocated to logical channels in a second array to complete group operation of the logical channels in the second array,

and sizes of the data spaces may be sums of sizes of all data on the logical channels corresponding to the data spaces.

Preferably, before the step that the data spaces are sequentially allocated to the logical channels in the first array to complete group operation of the logical channels in the first array, the method may further include that:

logical channels meeting a set condition are put into the first array, and other logical channels are put into the second array.

Preferably, the set condition may be that: a token bucket value of a logical channel is larger than 0 and/or a PBR of a logical channel is infinitely large.

Preferably, the method may include that the token bucket values of the logical channels are updated before a moment at which a Transmission Time Interval (TTI) arrives:

the token bucket value of the logical channel is read;

a set value is added to the token bucket value of the logical channel; and

whether the token bucket value of the logical channel is smaller than threshold value or not at this moment is judged, the token bucket value of the next logical channel is updated if YES, otherwise the threshold value is determined as the token bucket value of the logical channel, and the token bucket value of the next logical channel is updated.

Preferably, the set value may be current PBR of the logical channel.

The embodiment of the disclosure also provides a group operation device for logical channels in an LTE system, which may include:

a first group operation unit, configured to sequentially allocate data spaces to logical channels in a first array to complete group operation of the logical channels in the first array; and

a second group operation unit, configured to sequentially allocate data spaces to logical channels in a second array to complete group operation of the logical channels in the second array, and sizes of the data spaces may be sums of sizes of all data on the logical channels corresponding to the data spaces.

Preferably, the device may further include:

a logical channel allocation unit, configured to put logical channels meeting a set condition into the first array, and put logical channels not meeting the set condition into the second array.

Preferably, the logical channel allocation unit may include:

a limiting module, configured to group the logical channels through the set condition, wherein the set condition may be that: token bucket value of the logical channel is larger than 0 and/or a PBR of the logical channel is infinitely large.

Preferably, the device may include:

an updating unit, configured to update the token bucket values of the logical channels before a moment at which a TTI arrives.

Preferably, the updating unit may include:

an information reading module, configured to read the token bucket value of the logical channel;

an incremental module, configured to add set value to the token bucket value of the logical channel; and

an updating module, configured to judge whether the token bucket value of the logical channel is smaller than threshold value or not at this moment, update the token bucket value of the next logical channel if YES, otherwise determine the threshold value as the token bucket value of the logical channel, and update the token bucket value of the next logical channel.

According to the group operation method and device for the logical channels in the LTE system provided by the disclosure. The logical channels are divided into two groups according to the set condition, and then group operation is performed on the logical channels included in each group respectively, so that group operation is performed only once on the same logical channel in the same period. The situation that group operation is performed for many times or no group operation is performed on the same logical channel is avoided, and data processing efficiency is improved.

### BRIEF DESCRIPTION OF THE DRAWINGS

FIG. 1 is an implementation flowchart of a group operation method for logical channels in an LTE system according to embodiment 1 of the disclosure;

FIG. 2 is a structure diagram of a group operation device for logical channels in an LTE system according to embodiment 2 of the disclosure;

FIG. 3 is a flowchart of updating B values of logical channels according to embodiment 3 of the disclosure;

FIG. 4 is a flowchart of priority processing of logical channels according to embodiment 3 of the disclosure;

FIG. 5 is a flowchart of group operation of SDUs according to embodiment 3 of the disclosure;

FIG. 6 is a flowchart of cyclically performing logical channel priority processing on each carrier resource according to embodiment 3 of the disclosure; and

FIG. 7 is a flowchart of combining each carrier resource to perform logical channel priority processing once according to embodiment 3 of the disclosure.

### DETAILED DESCRIPTION

The technical solutions of the disclosure will be further elaborated below with reference to the drawings of the specification and specific embodiments.

### Embodiment 1

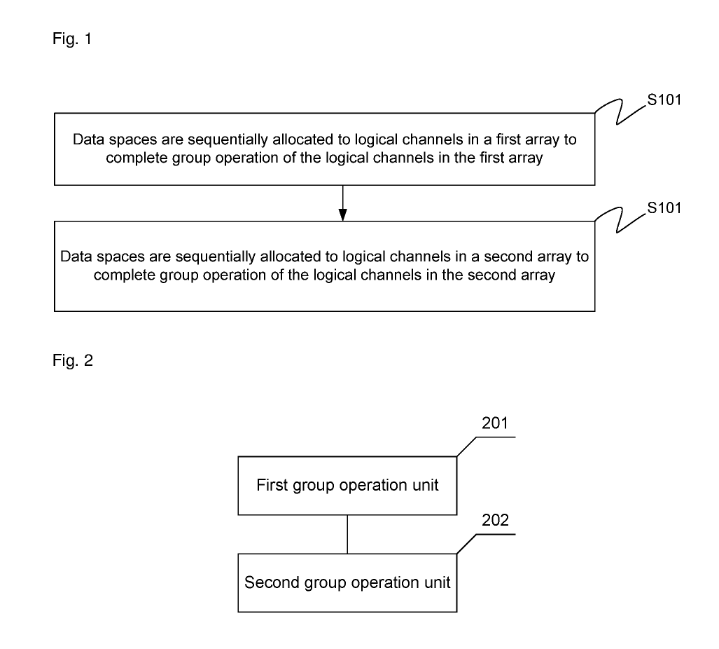

In order to solve the technical problem of the conventional art, the embodiment provides a group operation method for logical channels in an LTE system. As shown in FIG. 1, the method includes:

S101: data spaces are sequentially allocated to logical channels in a first array to complete group operation of the logical channels in the first array; and

S102: data spaces are sequentially allocated to logical channels in a second array to complete group operation of the logical channels in the second array.

In Step S101 to S102, sizes of the data spaces are sums of sizes of all data on the logical channels corresponding to the data spaces.

According to the embodiment, the logical channels are divided into two groups according to a set condition, and then group operation is performed on the logical channels included in each group respectively, so that group operation is performed only once on a same logical channel in the same period, the situation that group operation is performed for many times or no group operation is performed on a same logical channel is avoided, and data processing efficiency is improved.

Before Step S101, the method further includes Step S100: logical channels meeting the set condition are put into the first array, and logical channels not meeting the set condition are put into the second array.

In the step S100, the logical channels meeting the set condition may be put into the first array according to a sequence from high to low priorities of the logical channels, and here, the priorities of the logical channels are automatically allocated by a network side.

In the embodiment, the logical channels requiring for group operation are grouped according to a same standard, so that the situation that group operation is performed for many times or no group operation is performed on a same logical channel may be avoided.

Specifically, the set condition in Step S100 is determined to be that: the token bucket value of a logical channel is larger than 0 and/or the PBR of a logical channel is infinitely large. In such a manner, the logical channels of which the priorities are higher and the token bucket values are larger than 0 may be preferably processed, while the logical channels of which the PBRs are infinitely large may provide sufficient processing capabilities for single data processing. Here, the token bucket values of the logical channels of which the PBRs are infinitely large may be smaller than or equal to 0. Therefore, the set condition of the embodiment may be more favourable for effective processing of the data compared with an existing method.

In Step S101, the operation that the data spaces are sequentially allocated to the logical channels in the first array to complete group operation of the logical channels in the first array includes the following steps.

S1011: the logical channels are read from the first array according to a sequence from high to low priorities of the logical channels.

Here, reading the logical channels according to the sequence from high to low priorities of the logical channels may ensure that the logical channels with higher logical channel priorities preferably process the data.

S1012: the data spaces are allocated to the logical channels, and at this moment the sizes of the data spaces are the sums of the sizes of all the data on the logical channels corresponding to the data spaces in the first array.

S1013: group operation is performed on SDUs on the logical channels.

S1014: SDU sub-headers are structured for the SDUs of which group operation is completed.

The SDU sub-headers include information such as sizes of the SDUs and serial numbers of the logical channels and so on, and are configured to indicate the sizes of the SDUs and the like.

S1015: values of the SDUs on the logical channels are subtracted from the token bucket values of the logical channels to obtain current token bucket values of the logical channels.

S1016: the values of the SDUs and values of the SDU sub-headers are subtracted from the data spaces to obtain a current residual data space.

If an existing data space has been completely allocated to the logical channels in the first array, or group operation of all the SDUs on the logical channels has been completed, group operation may be ended at this moment; otherwise Step S102 is performed.

Step S102 is a step which is performed only if there are still SDUs requiring for group operation after group operation of the logical channels in Step S101 is completed. The specific operation steps in step S102 are similar to those in Step S101, including:

S1021: the logical channels are read from the second array according to a sequence from high to low priorities of the logical channels;

S1022: the data spaces are allocated to the logical channels, and the sizes of the data spaces at this moment are the sums of the sizes of all the data on the logical channels corresponding to the data spaces in the second array;

S1023: group operation is performed on SDUs on the logical channels;

S1024: SDU sub-headers are structured for each SDU of which group operation is completed;

S1025: values of the SDUs on the logical channels are subtracted from the token bucket values of the logical channels to obtain current token bucket values of the logical channels; and

S1026: the values of the SDUs and values of the SDU sub-headers are subtracted from the data spaces to obtain a current residual data space.

Step S101 to S102 are group operation steps performed in a period, and before a starting moment (the moment at which the Transmission Time Interval—TTI arrives) of the next period, it is also necessary to update the token bucket values, including the following steps.

S1: the token bucket value of the logical channel is read.

Here, the token bucket value at this moment is the token bucket value after group operation in Step S101 and Step S102.

S2: a set value is added to the token bucket value of the logical channel.

Here, the set value is the current PBR of the logical channel, and the PBR may reflect single group operation capabilities of the logical channel for the SDUs.

S3: whether the token bucket value of the logical channel is smaller than threshold value or not at this moment is judged, the token bucket value of the next logical channel is updated if YES, otherwise the threshold value is determined as the token bucket value of the logical channels, and the token bucket value of the next logical channel is updated.

Here, the threshold values are calculated by N=PBRⱼ×BSDⱼ,

where N is the threshold value; PBRⱼ is the PBR of the jth logical channel; and BSDⱼ is a Bucket Size Duration (BSD) of the jth logical channel, and j is a natural number.

By the abovementioned steps, group operation is performed only once on the same logical channel in the same period, the situation that group operation is performed for many times on the logical channel is avoided, and the data processing efficiency is improved.

### Embodiment 2

The embodiment belongs to the same inventive concept as embodiment 1. The embodiment provides a resource allocation device for logical channels in an LTE system. As shown in FIG. 2, the device includes:

a first group operation unit 201, configured to sequentially allocate data spaces to logical channels in a first array to complete group operation of the logical channels in the first array.

Specifically, the first group operation unit 201 further includes:

a first reading module, configured to read the logical channels from the first array according to a sequence from high to low priorities of the logical channels. The reading of the logical channels according to the sequence from high to low priorities of the logical channels may ensure preferable processing of the logical channels with higher priorities;

a first allocation module, configured to allocate the data spaces to the logical channels, sizes of the data spaces being sums of sizes of all data on the logical channels corresponding to the data spaces in the first array at this moment;

a first group operation module, configured to perform group operation on SDUs on the logical channels;

a first SDU sub-header structuring module, configured to structure SDU sub-headers for the SDUs of which group operation is completed;

a first token bucket value processing module, configured to subtract values of the SDUs on the logical channels from token bucket values of the logical channels to obtain current token bucket values of the logical channels; and

a first data space processing module, configured to subtract the values of the SDUs and values of the SDU sub-headers from the data spaces to obtain a current residual data space.

If an existing data space has been completely allocated to the logical channels in the first array, or group operation of all the SDUs on the logical channels has been completed, group operation may be ended at this moment. Otherwise data processing is performed through a second group operation unit 202.

The second group operation unit 202 is configured to sequentially allocate data spaces to logical channels in a second array to complete group operation of SDUs on the logical channels in the second array. The sizes of the data spaces are sums of sizes of all data on the logical channels corresponding to the data spaces.

Specifically, the second group operation unit 202 further includes:

a second reading module, configured to read the logical channels from the second array according to a sequence from high to low priorities of the logical channels. The reading of the logical channels according to the sequence from high to low priorities of the logical channels may ensure preferable processing of the logical channels with higher priorities;

a second allocation module, configured to allocate the data spaces to the logical channels, the sizes of the data spaces being the sums of the sizes of all the data on the logical channels corresponding to the data spaces in the second array at this moment;

a second group operation module, configured to perform group operation on SDUs on the logical channels;

a second SDU sub-header structuring module, configured to structure SDU sub-headers for the SDUs of which group operation is completed;

a second token bucket value processing module, configured to subtract values of the SDUs on the logical channels from token bucket values of the logical channels to obtain current token bucket values of the logical channels; and

a second data space processing module, configured to subtract the values of the SDUs and values of the SDU sub-headers from the data spaces to obtain a current residual data space.

In addition, the device of the embodiment further includes:

an updating unit 203, configured to update the token bucket values before a movement at which a TTI arrives.

Specifically, the updating unit 203 further includes:

an information reading module 2031, configured to read the token bucket value of the logical channel;

an incremental module 2032, configured to add set value to the token bucket value of the logical channel; and

an updating module 2033, configured to judge whether the token bucket value of the logical channel is smaller than threshold value or not at this moment, update the token bucket value of the next logical channel if YES, otherwise determine the threshold value as the token bucket value of the logical channel, and update the token bucket value of the next logical channel.

Here, the threshold values are calculated by N=PBRⱼ×BSDⱼ,

where N is the threshold value; PBRⱼ is the PBR of the jth logical channel; and BSDⱼ is a BSD of the jth logical channel, and j is a natural number.

The device of the embodiment may further include a logical channel allocation unit 200, configured to put logical channels meeting a set condition into the first array, and put logical channels not meeting the set condition into the second array.

Herein, the logical channels meeting the set condition may be put into the first array according to the sequence from high to low priorities of the logical channels, and the priorities of the logical channels are automatically allocated by a network side.

In the embodiment, the logical channels with a group operation requirement are grouped according to the same standard, so that the phenomenon that group operation is performed for many times or no group operation is performed on the same logical channel may be avoided.

Specifically, the logical channel allocation unit 200 further includes:

a limiting module 2001, configured to group the logical channels through the set condition,

The set condition is that the token bucket values of the logical channels are larger than 0 and/or PBRs of the logical channels are infinitely large. In such a manner, the logical channels of which the token bucket values are larger than 0 may be processed in priority, while the logical channels of which the PBRs are infinitely large may provide sufficient processing capabilities for single data processing. Here, the token bucket values of the logical channels of which the PBRs are infinitely large may be smaller than or equal to 0. Therefore, the set condition of the embodiment may be more favourable for effective processing of the data compared with an existing method.

By the abovementioned steps, group operation is performed only once on the same logical channel in the same period, the situation that group operation is performed for many times on the logical channel is avoided, and the data processing efficiency is improved.

### Embodiment 3

The disclosure will be described in detail in the embodiment through a practical scenario.

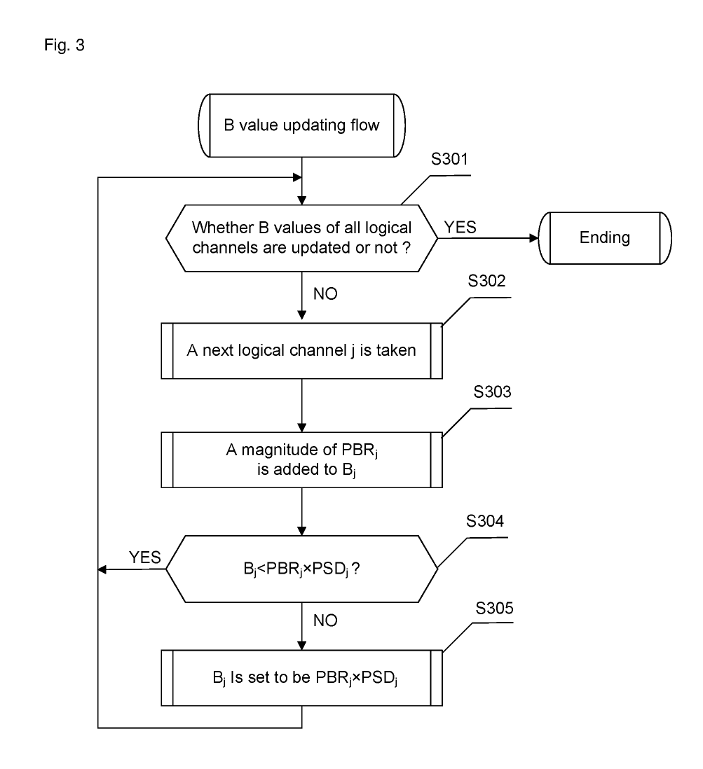

Before a logical channel priority processing process is performed, it is necessary to update B values at first. A flow of updating the B values is shown in FIG. 3, and the B value of each logical channel is set to be 0 when the logical channels are initially established, and an addition operation is performed on each TTI, including:

S301: whether the B values of all the logical channels have been updated or not is judged, the flow is ended if YES, otherwise the next step is continued;

S302: the next logical channel of which the B value is required to be updated is read, a serial number of the logical channel being set to be j;

S303: a magnitude of PBR is added to Bⱼ, wherein PBRⱼ is a PBR of the jth logical channel, specifies an increment of Bⱼ on each TTI, and is configured to user equipment by a network;

S304: whether Bⱼ is smaller than a threshold value N or not is judged, Step 1 is executed if YES, otherwise the next step is continued, wherein the threshold value N is calculated by N=PBRⱼ×BSDⱼ. BSD_{J} is a BSD of the jth logical channel, specifying an upper limit of the Bⱼ value of the logical channel, and is configured to a terminal side by a network side; and

S305: Bⱼ is set to be the threshold value N.

After the B values are updated, the following logical channel priority processing process is performed on each TTI.

In a first step, the logical channels of which the B values are larger than 0 or PBRs are infinitely large are stored in an array ActiveLchB[] according to a sequence from high to low priorities of the logical channels.

Then, an RLC module is notified to group MAC SDUs, the MAC SDUs being grouped according to the sequence stored in the array. When grouping the MAC SDUs on a logical channel, the RLC module groups data on the logical channel by virtue of all current available residual data spaces. After the first step is completed, sizes of the actually grouped MAC SDUs are progressively subtracted from the B values of each logical channel, and if there is still left a data space, a third step is executed.

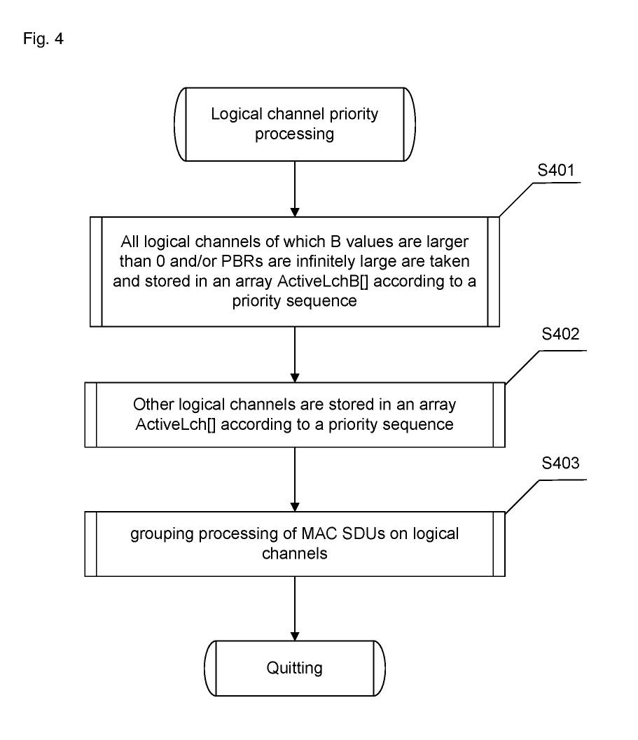

In the third step, other logical channels are stored in an array ActiveLch[] according to a sequence from high to low priorities of the logical channels. MAC SDUs are also grouped according to the sequence stored. When a logical channel is grouped, the SDUs on the logical channel are also grouped by virtue of all current available residual data spaces. As shown in FIG. 4, the following steps are included.

S401: all the logical channels of which the B values are larger than 0 and/or the PBRs are infinitely large are stored in the array ActiveLchB[] according to the sequence from high to low priorities of the logical channels.

S402: other logical channels are stored in the array ActiveLch[] according to the sequence from high to low priorities of the logical channels.

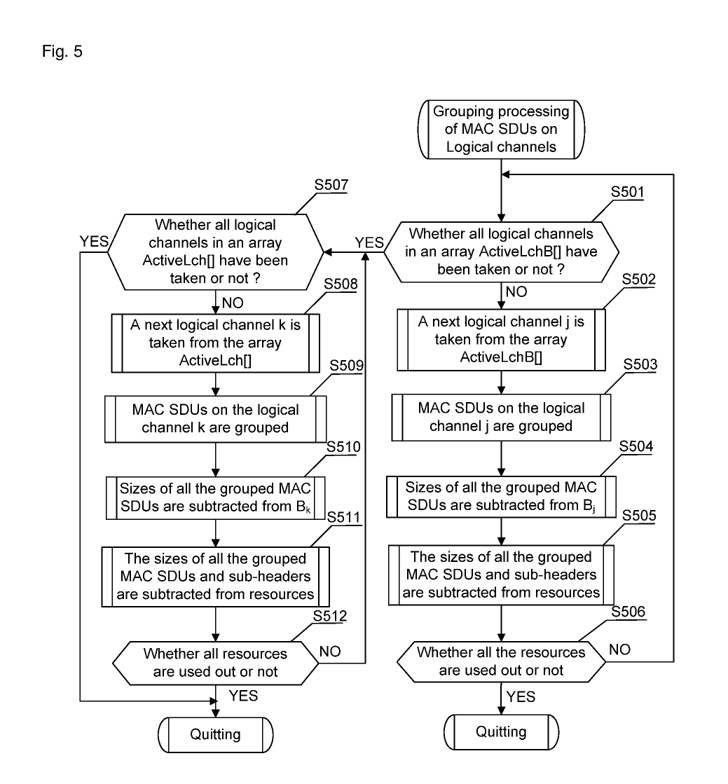

S403: the MAC SDUs on each logical channel are grouped by virtue of the current available data spaces until all the current available data spaces are used out or data on all the logical channels has been grouped. A specific flow is shown in FIG. 5.

A processing process for grouping the MAC SDUs on the logical channels is as follows.

S501: whether the logical channels in the array ActiveLchB[] have been taken or not is judged, Step S507 is executed if YES, otherwise the next step is continued.

S502: the next logical channel j is taken from the array ActiveLchB[].

S503: the MAC SDUs on the logical channel j are grouped, and every time when a MAC SDU is grouped, a corresponding MAC SDU sub-header is structured.

S504: the sizes of all the grouped MAC SDUs are subtracted from Bⱼ.

S505: the sizes of all the grouped MAC SDUs and the MAC SDU sub-headers are subtracted from the available data spaces.

S506: whether current data spaces are sufficient for grouping the next MAC SDU or not is judged, Step S501 is executed if YES, otherwise the flow is ended.

S507: whether all the logical channels in the array ActiveLch[] have been taken or not is judged, the flow is ended if YES, otherwise the next step is continued.

S508: the next logical channel k is taken from the array ActiveLch[].

S509: the MAC SDUs on the logical channel k are grouped, and every time when a MAC SDU is grouped, a corresponding MAC SDU sub-header is structured.

S510: the sizes of all the grouped MAC SDUs are subtracted from Bₖ.

S511: the sizes of all the grouped MAC SDUs and the MAC SDU sub-headers are subtracted from the available data spaces.

S512: whether current data spaces are sufficient for grouping MAC SDUs or not is judged, Step S507 is executed if YES, otherwise the flow is ended.

Carrier aggregation is introduced into an Evolved-Universal Mobile Telecommunications System Terrestrial Radio Access (E-UTRA) release 10, and user equipment aggregates multiple available carriers for uplink and downlink data transmission under carrier aggregation, thereby increasing a transmission rate. With introduction of carrier aggregation, data spaces may be allocated to each available carrier on each 1-millisecond TTI, and if n (n>=0) uplink resources are allocated, the user equipment performs logical channel priority processing according to the n uplink resources, thereby grouping n MAC PDUs.

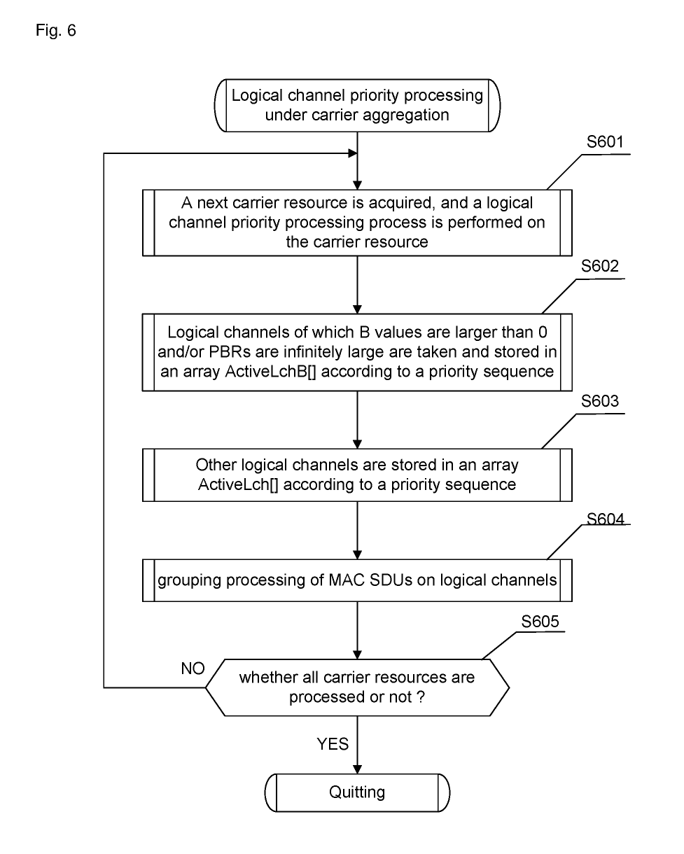

The abovementioned logical channel priority processing method may also be applied to a carrier aggregation scenario. When logical channel priority processing is performed under carrier aggregation, it is also necessary to update B values at first, and an updating flow for the B values is shown in FIG. 3. Meanwhile, it is necessary to consider available data spaces on multiple carriers under carrier aggregation. There are two methods for processing the available data spaces on these carriers, and the first method is to cyclically perform logical channel priority processing on each carrier resource, as shown in FIG. 6.

S601: a next carrier resource is acquired, and a logical channel priority processing process is performed on the carrier resource.

S602: logical channels of which B values are larger than 0 and/or PBRs are infinitely large are stored in an array ActiveLchB[] according to a sequence from high to low priorities of the logical channels.

S603: other logical channels are stored in an array ActiveLch[] according to a sequence from high to low priorities of the logical channels.

S604: grouping processing of MAC SDUs on logical channels is performed, a method for grouping processing of MAC SDUs on logical channels being shown in FIG. 3.

S605: whether all carrier resources are processed or not is judged, the flow is ended if YES, otherwise Step S601 is executed.

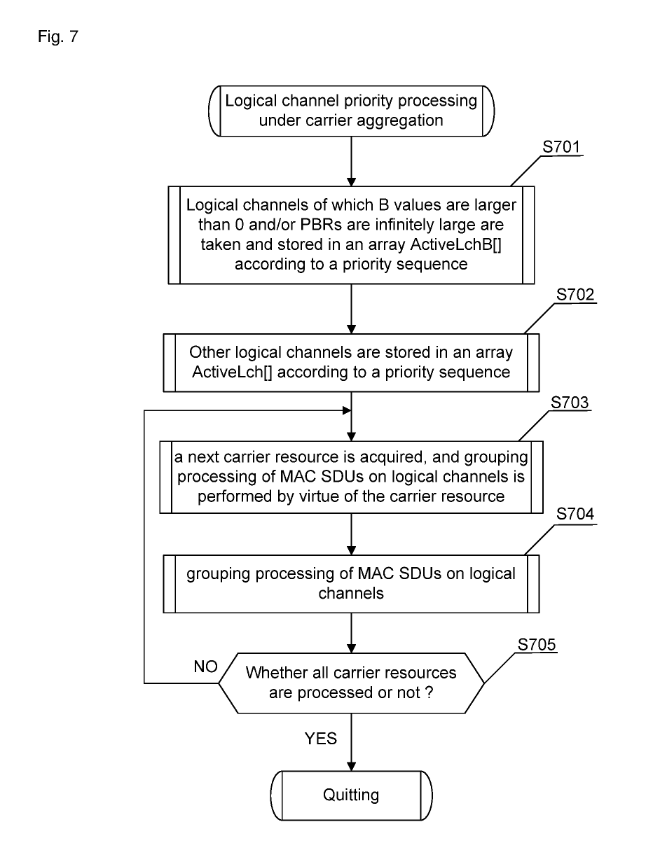

The second method is to combine each carrier resource to perform logical channel priority processing once, as shown in FIG. 7.

S701: the logical channels of which the B values are larger than 0 and/or the PBRs are infinitely large are stored in the array ActiveLchB[] according to the sequence from high to low priorities of the logical channels.

S702: all the other logical channels are stored in the array ActiveLch[] according to the sequence from high to low priorities of the logical channels.

S703: the next carrier resource is acquired, and MAC SDUs of each logical channel are grouped by virtue of the carrier resource.

S704: grouping processing of MAC SDUs on logical channels is performed, a method for grouping processing of MAC SDUs on logical channels being shown in FIG. 5.

S705: whether all the carrier resources are processed or not is judged, the flow is ended if YES, otherwise Step S703 is executed.

In some embodiments provided by the disclosure, it should be understood that the disclosed equipment and method may be implemented in another manner. The equipment embodiment described above is only schematic, and for example, division of the units is only logic function division, and other division manners may be adopted during practical implementation. For example, multiple units or components may be combined or integrated into another system, or some characteristics may be neglected or not executed. In addition, coupling or direct coupling or communication connection between each displayed or discussed component may be indirect coupling or communication connection, implemented through some interfaces, or the equipment or the units, and may be electrical, mechanical or adopt other forms.

The abovementioned units described as separate parts may or may not be physically separated, and parts displayed as units may or may not be physical units, and namely may be located in the same place, or may also be distributed to multiple network units. Part or all of the units may be selected to achieve the purpose of the solutions of the embodiment according to a practical requirement.

In addition, each function unit in each embodiment of the disclosure may be integrated into a processing unit, each unit may also exist independently, and two or more than two units may also be integrated into a unit. The abovementioned integrated unit may be implemented in a hardware form, and may also be implemented in form of hardware and software function unit.

Those skilled in the art should know that: all or part of the steps of the abovementioned method embodiment may be implemented by instructing related hardware through a program, the abovementioned program may be stored in a computer-readable storage medium, and the program is executed to execute the steps of the abovementioned method embodiment; and the abovementioned storage medium includes: various media capable of storing program codes such as mobile storage equipment, a Read-Only Memory (ROM), a Random Access Memory (RAM), a magnetic disk or an optical disk.

The above is only the specific implementation mode of the disclosure and not intended to limit the scope of protection of the disclosure, and any variations or replacements apparent to those skilled in the art within the technical scope disclosed by the disclosure shall fall within the scope of protection of the disclosure. Therefore, the scope of protection of the disclosure shall be subject to the scope of protection of the claims.

### INDUSTRIAL APPLICABILITY

The disclosure discloses the group operation method and device for the logical channels in the LTE system. The logical channels may be divided into two groups according to the set condition, and then group operation is performed on the logical channels included in each group respectively, so that group operation is performed only once on the same logical channel in the same period. The situation that group operation is performed for many times or no group operation is performed on the same logical channel is avoided, and data processing efficiency is improved.

1. A group operation method for logical channels in a Long Term Evolution (LTE) system, comprising:
sequentially allocating data spaces to logical channels in a first array to complete group operation of the logical channels in the first array; and
sequentially allocating data spaces to logical channels in a second array to complete group operation of the logical channels in the second array,
wherein sizes of the data spaces are sums of sizes of all data on the logical channels corresponding to the data spaces.

2. The method according to claim 1, before sequentially allocating the data spaces to the logical channels in the first array to complete group operation of the logical channels in the first array, further comprising:
putting logical channels meeting a set condition into the first array, and putting other logical channels into the second array.

3. The method according to claim 2, wherein the set condition is that:
a token bucket value of a logical channel is larger than 0 and/or a Prioritised Bit Rate (PBR) of a logical channel is infinitely large.

4. The method according to claim 1, comprising updating the token bucket values of the logical channels before a moment at which a Transmission Time Interval (TTI) arrives:
reading the token bucket value of the logical channel;
adding a set value to the token bucket value of the logical channel; and
judging whether the token bucket value of the logical channel is smaller than threshold value or not at this moment, updating the token bucket value of the next logical channel if YES, otherwise determining the threshold value as the token bucket value of the logical channel, and updating the token bucket value of the next logical channel.

5. The method according to claim 4, wherein the set value is the current PBR of the logical channel.

6. A group operation device for logical channels in a Long Term Evolution (LTE) system, comprising:
a processor; and
a memory for storing instructions executable by the processor;
wherein the processor is configured to: sequentially allocate data spaces to logical channels in a first array to complete group operation of the logical channels in the first array; and
sequentially allocate data spaces to logical channels in a second array to complete group operation of the logical channels in the second array, wherein sizes of the data spaces are sums of sizes of all data on the logical channels corresponding to the data spaces.

7. The device according to claim 6, wherein:
the processor is configured to put logical channels meeting a set condition into the first array, and put logical channels not meeting the set condition into the second array.

8. The device according to claim 7, wherein:
the processor is further configured to group the logical channels through the set condition, and the set condition is that: a token bucket value of a logical channel is larger than 0 and/or a Prioritised Bit Rate (PBR) of the logical channel is infinitely large.

9. The device according to claim 7, wherein:
the processor is further configured to update the token bucket values of the logical channels before a moment at which a Transmission Time Interval (TTI) arrives.

10. The device according to claim 9, wherein:
the processor is configured to read the token bucket value of the logical channel;
add a set value to the token bucket value of the logical channel; and
judge whether the token bucket value of the logical channel is smaller than threshold value or not at this moment, update the token bucket value of the next logical channel if YES, otherwise determine the threshold value as the token bucket value of the logical channel, and update the token bucket value of the next logical channel.

11. A computer storage medium, in which a computer-executable instruction is stored, the computer-executable instruction being configured to execute the method according to claim 1.
